(19) United States
(12) Patent Application Publication
(10) Pub. No.: US 2021/0080393 A1
(43) Pub. Date: Mar. 18, 2021

(54) Using Quantum Dots for Identification, Authentication, and Tracking of Objects

(71) Applicant: Quantum Materials Corp., San Marcos, TX (US)

(72) Inventors: Jay M. Williams, Austin, TX (US); Stephen Squires, San Marcos, TX (US)

(21) Appl. No.: 17/024,640

(22) Filed: Sep. 17, 2020

Related U.S. Application Data
(60) Provisional application No. 62/901,778, filed on Sep. 17, 2019.
(60) Provisional application No. 62/901,787, filed on Sep. 17, 2019.

(51) Int. Cl. G01N 21/64

(52) U.S. Cl. CPC G01N 21/643; B82Y 20/00

(57) ABSTRACT

Systems, methods, apparatus and techniques for authenticating objects includes applying quantum dots to an object, wherein the quantum dots have an identified spectral response pattern, and recording data associating the object and the identified spectral response pattern.

### RELATED APPLICATIONS

This application claims priority to U.S. Provisional Application No. 62/901,778 filed Sep. 17, 2019 and U.S. Provisional Application No. 62/901,787 filed Sep. 17, 2019, both of which are incorporated herein by reference in their entirety.

### BACKGROUND

This description relates to quantum dots, and more particularly to the use of quantum dots for identification, authentication, and/or tracking possession or ownership of objects.

Quantum dots (QDs) are tiny synthetically-manufactured or synthetically-created semiconductor particles a few nanometers (e.g., 10-100 atoms in diameter, 2-10 nm across, or 2 k-200 k atoms in volume) in size. Quantum dots are similar to naturally occurring molecules but have optical and electronic properties as a result of quantum mechanics. Quantum dots are so named because the motion of their constituent electrons is restricted (quantum-confined), which results in their broad absorption and discrete emission of light. When semiconducting quantum dots are illuminated by UV light, an electron in the quantum dot can be excited to a state of higher energy corresponding to the transition of an electron from the valence band to the conductance band. When the excited electron drops back into the valence band, it releases energy through an emission of light. The color of that light depends on the energy difference between the conductance band and the valence band, which in turn is dependent upon the size, shape, and composition of the particular quantum dot, in addition to being dependent on external factors, such as ambient conditions like temperature and the type of substrate (physical item) or solvent in which the quantum dots are located.

### DESCRIPTION OF DRAWINGS

FIG. 1 is a flow diagram of a process for using quantum dots.

FIG. 2 is a flow diagram of a process for user registration.

FIG. 3 is a flow diagram of a sigil creation process.

FIG. 4 is a logical diagram of roles and persons that can participate in the systems and methods of the present disclosure.

FIG. 5 is an example of a product having embedded quantum dots and a scanner for detecting spectral signatures of quantum dots.

FIG. 6 is an illustrative graph of a spectral signature of a batch of quantum dots.

FIG. 7 is a flow diagram of a process for identifying and authenticating a product using quantum dots embedded in the product.

FIG. 8 is an example of a physical stamping device for applying a representation of a sigil or brand to an object.

FIG. 9 is an illustrative example of a record for a product having embedded quantum dots.

Like reference symbols in the various drawings indicate like elements.

### DETAILED DESCRIPTION

In accordance with aspects described in this specification, quantum dots are produced that are finely tuned to emit unique specific color signatures or patterns that cannot be reproduced. The specific color signature can also result from controlling the propensity of absorbance to light—for instance, a quantum dot may absorb more 500 nm cyan light photons as compared to 450 nm blue light photons. The excitation source light can include one or more wavelengths from the entire light spectrum including, for example, all or less than all visible light and/or ultraviolet light. The specific excitation wavelength can be dictated by the specific quantum dot or dots that are represented in the optical signature. Such variations in excitation wavelengths add to the complexity of color signature detection and repeatability. The quantum dots (or the specific color signatures and/or identified excitation wavelengths or sources) are serialized into a blockchain using utility tokens, meaning that that each token performs some digital function rather than storing a value. The specific color pattern may, for example, be associated with quantum dots that emit certain colors (e.g., having a very narrow spectral response) within the overall light spectrum. The specific color pattern may also be associated with one or more identified excitation sources. These quantum dots can be incorporated into almost any physical item at a tamper-proof molecular level. The association between the quantum dots and the physical item can be recorded in the blockchain. Throughout this specification, although the term blockchain may be used, it will be understood that the data may be recorded in a distributed ledger, without necessarily being limited to blockchain.

Any subsequent purchase or transfer of ownership or possession of the item (or other operations on the item, including movement, incorporation into a system, etc.) can also be recorded in the blockchain. Thereafter, the dots and the physical item can be authenticated, interacted with, traced and tracked. For example, using an app on a mobile device with a built in scanner (e.g., a UV light emitter and a spectrometer capable of detecting a sufficient spectral resolution, such as at least 10 nm nanometers; an alternative implementation may include a spectral resolution of 0.5-10 nm, with a signal to noise ratio>500:1, and an accuracy of at least ±1 nm), a physical item can be scanned (e.g., at a known location on the item where the quantum dots are incorporated). The color signature that is detected can be compared to the data serialized in the blockchain to, for example, authenticate the item, transfer ownership, or track its location. The blockchain platform additionally can allow for an integrated payment system (e.g., a shopping cart) that works together with the quantum dots to offer a physically integrated frictionless identification, authorization, and payment system on blockchain. Among other things, the platform can be used for anti-counterfeiting (e.g., to validate that an item is a genuine product), identity management, and brand security into existing supply chains and products.

The platform can also be used to authenticate and document actors and transactions that interact with the physical items. Individuals and companies, for example, can purchase physical stamping devices that can be used to imprint a unique image-based identifier of the individual or company. A physical stamping device can be used in combination with an ink that contains a specific color signature assigned to the individual or company to authorize a transaction (e.g., a transfer of ownership). For example, a user can stamp a document with the image-based identifier in ink with the assigned color signature. The physical stamping device can further include built-in authentication feature to, for example, authenticate the user through biometrics.

Stamp tokens (e.g., utility tokens) can also be used in combination with quantum dots having a specific color signature, with or without the physical stamping devices, to validate the identity of an actor (through a distributed identity provider) or an object that does not already have an assigned identity (i.e., does not have embedded dots that are already tied to a token in blockchain), authenticate participants in the transaction (e.g., by communicating with third party oracles, such as to confirm whether a participant has a particular certification), and authorize an action (e.g., to make sure that a person has the authority to take a particular action).

As an illustrative example of one use of an overall system that uses quantum dots is to track a product through its lifecycle. A manufacturer of a designer purse may embed, as part of its manufacturing process, quantum dots having a particular spectral signature into a particular location on its products. The particular spectral signature may be unique or otherwise assigned to the manufacturer. Accordingly, throughout the product lifecycle, the manufacturer, potential purchasers, and other third parties can determine whether a product is a genuine product of the manufacturer by using an authentication scanner to detect the spectral signature, which can be validated against data stored in a QDX™ ledger (i.e., blockchain associated with the quantum dots). A consumer that purchases a product can imprint his or her own sigil (described below) using a physical stamp and quantum dots having a spectral signature assigned to the consumer. Both the physical stamp and the quantum dots can be purchased by the consumer and the association of the physical stamp and the quantum dots with the consumer can be recorded in the QDX™ ledger. This purchase transaction can be recorded, along with the identity of the consumer as reflected by the imprinted quantum dots, as a token in the QDX™ ledger. Thereafter, the consumer can sell the product to a third party through a transaction that can include validating the authenticity of the product using the embedded quantum dot signature; validating the identity of the consumer (through a distributed identity provider) to confirm that the consumer is the valid owner and recording the identity using an identity stamp; and validating that the third party buyer is authorized to make the purchase (e.g., that she has enough money in her account) and recording the authorization in an authorization stamp. In some cases, the identity stamp and the authorization stamp may be tied to quantum dots with their personalized specific signature pattern, while in other cases these utility stamps can be tied through the QDX™ ledger to the quantum dots already associated with the product.

In some implementations, a quantum reactor produces quantum dots (e.g., using a continuous flow process, such as those available from, or described in patents assigned to, Quantum Materials Corp., San Marcos, Tex., or other appropriate process) that have a specific color signature. An individual signature is created by combinations of very specific wavelengths for each batch of quantum dots. For example, the quantum dots, when exposed to UV light, emit light having a specific set of color characteristics (e.g. in six or more narrow spectral bands). The quantum dots can be produced to have a predetermined specific set of color characteristics (i.e., such that the dots emit light having a spectral pattern that is preselected), or the quantum dots can be produced without knowing the precise spectral pattern that will result, but the precise spectral pattern can subsequently be measured and recorded. In some implementations, the quantum dots may be produced to have a predetermined specific set of color characteristics at a first level of specificity (e.g., to generate light within very narrow spectral bands), but the actual quantum dots produced may have characteristics that can be more precisely measured at a second level of specificity (e.g., the specific spectral response within the very narrow spectral bands), such that a specific batch of quantum dots can be distinguished from other batches that have the predetermined specific set of color characteristics at a first level of specificity. As one example, a unique signature may be created by quantum dots that emit six or more bands of light, measured in nanometers, which can be serialized into a value similar to an IP address with 6 (or more) values that acts as a unique identifier. The quantum dots can also emit light across the entire spectrum so it is possible to have emissions that are undetectable by the human eye, although the spectral signature may be embedded in specific variations across the spectrum. By controlling the materials, temperature, and pressure in the quantum reactor, quantum dots can be produced with the desired characteristics of light. In general, the quantum dots may be produced by, or using equipment available from, Quantum Materials Corp. of San Marcos, Tex.

To produce specific quantum dots for a manufacturer (or any party), control software for a quantum reactor can be used to produce a specific kind of dot according to a specification, which uses a recipe and materials to generate the desired kind of dot. A dot manufacturer can be assigned a Reactor ID (QRID) which is registered to each Quantum Reactor (QR). A specification for the creation of quantum dot objects (e.g., products or other objects with embedded quantum dots that are tied to the object) contains a quantum dot recipe for a reactor process, which defines materials, materials processes, and expected output.

A distributed ledger (e.g., blockchain) can be used to record and create tokenized versions of the quantum dots. After being produced, the quantum dots can be embedded in any type of material (leather, wood, plastics, metal, liquids, etc.) and can be bonded at molecular level. For example, the quantum dots can be tied into a manufacturing process to embed the dots into products as the products are produced. The embedded dots are useful, for example, in anti-counterfeiting efforts (e.g., to validate that e-cigarettes, syringes, or other products are authentic), to identify the point of origin of liquids, etc. Using the tokenized quantum dots embedded in the goods, such goods can be represented or connected directly to the distributed ledger or blockchain. The quantum dots and the associated goods can thus be tracked in a QDX™ ledger.

A quantum reader or authenticator is used to scan and read quantum dots inside of or adhered to an object. A quantum reader may have a spectral resolution, for example, down to a 10 nanometers level, or a level of 0.5 nm-10 nm, with a signal to noise ratio>500:1 and an accuracy of at least ±1 nm. The quantum reader can be an industrial reader that is made specifically for the purpose of detecting the spectral response pattern of quantum dots. Such a reader can have a relatively high spectral resolution. The quantum reader may also be integrated into smartphones or other mobile devices. For example, blue light generated by a mobile phone can be used to activate dots and the built-in camera can differentiate emitted colors. In one implementation, a passive device, such as a diffraction grating or optical prism can be used to turn the smartphone camera into a spectrometer. In another implementation, an active device, like a handheld spectrometer (without a display) can be used to relay information to the smartphone to display and process the spectrum. A mobile app on the mobile phone can then detect the spectral response pattern of quantum dots in a particular product. The mobile app may also include a combination of the authenticator and a wallet. For example, the quantum wallet can include tokens that are tied to the QDX™ ledger for use in tokenizing objects or transactions.

In some implementations, physical stamps or “chops” (e.g., individual devices that carry a sigil (e.g., a personal representation or image, which may be a conventional signature, something analogous to a signature, or other unique design) or an entity “signature” (e.g., a commercial or business image, such as a brand or logo)) can be used in combination with the quantum dots. For example, quantum dots can be created in ink form and the physical stamps or chops can be used to apply the ink with the quantum dots to a document or other surface. QDX™ Physical Stamps are thus ink-based stamps that can imprint an assigned object identifier (AOI (Image)) using ink on a particular medium such as paper. Such an image can be linked to blockchain or other distributed ledger (e.g., the QDX™ ledger) and to an individual batch of dots to use for authentication and as wallet. For example, the image can be used to authenticate that a party to a transaction is who they say they are or to authorize a payment.

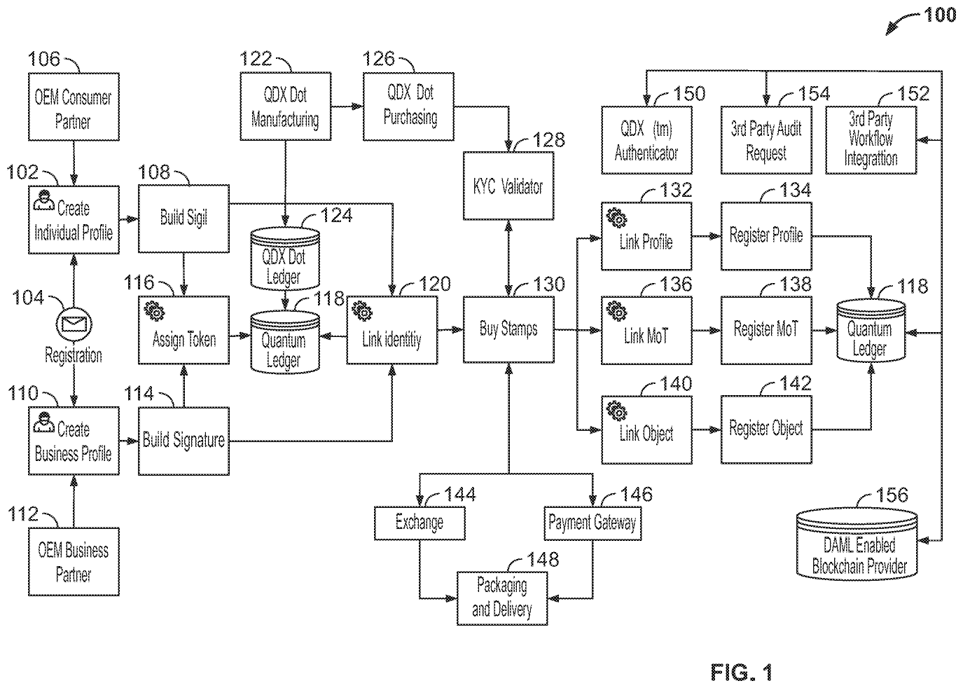

FIG. 1 depicts a flow diagram of a process 100 for using quantum dots. Individual profiles for identified individuals are created (at 102) as part of a registration process 104. The registration may be performed, for example, by a consumer facing entity 106 through a manual registration process. A unique sigil is defined or built (at 108) for each individual. Similarly, business profiles are created (at 110) for business partners as part of a business registration 104, which may also be a manual registration process through a business facing entity 112. A signature is identified or built (at 114) for the business. In general, a sigil and a signature are both graphical representations associated with an individual or entity. Corporate signatures can be brands or other unique signatures that identify companies. A sigil can be a personal signature or other unique graphical representation. Each sigil or signature is an assigned object that is automatically assigned a token (at 116). As a result, a token object representing the association between the token and the sigil or signature is written into the QDX™ or quantum ledger 118 and is used to link the identity of the individual or company to the sigil or signature. The identity is further linked (at 120) through an external decentralized identifier (DID) provider (e.g., that complies with a W3C DID specification or other similar DID specification or technique) to an email address or the like. A sigil or signature may also be incorporated into a sigil or signature device that includes, for example, a retina or fingerprint scanner or other type of system for authenticating the identity of a user.

As quantum dots are generated through a manufacturing process 122, metadata regarding the quantum dots is recorded to a dot ledger 124. The dot ledger 124 is a database for dots. It keeps track of dots through metadata that can include people, files and the like associated with the dots, while transactions and use and touching of those items are written to the blockchain in a QDX™ ledger 118. The dot metadata may include a batchID for the quantum dot batch and/or other information to identify the source of the dots (e.g., date and place of manufacture), data identifying the specific spectral signature for the dots, information about a product into which the dots are embedded (e.g., a photograph or other image, serial number, product line, model number, or other information that identifies the product either uniquely, semi-uniquely, or as part of a group of products), information about the customer, etc. A token for the quantum dots can also be generated and stored in the QDX™ ledger 118 (e.g., in blockchain).

In some cases, the quantum dots are integrated into a product or medium at the time of manufacture. In such cases, an assigned object can be created that is defined by a combination of the quantum dots and the product or medium. Details about the assigned object and its creation are written to the QDX™ ledger 118, while metadata about the assigned object is kept in the dot ledger 124. The QDX™ ledger 118 creates an object token when an assigned object is written and a binding of that object token to the assigned object ties the physical world and digital world together. In other cases, the quantum dots can be purchased (at 126) for later use in applying the dots to a medium or for other purposes (e.g., for use in solar applications or LED displays). Such dots can also be represented in the QDX™ ledger 118 by a dot token. These dots can subsequently be used to create an assigned object by a registered user or company through the use of stamps, which allow such an assigned object to be tied to an object token in the QDX™ ledger 118. Purchasers of quantum dots can be authenticated by a KYC (Know-Your-Customer) validator 128, such as an entity that provides validation for blockchain-based transactions, to ensure that the dots are purchased by a known entity or individual.

In general, quantum dots are provided to known individuals or entities for use in connection with purchased stamps (at 130). A stamp is an association between a quantum dot having a specific spectral or dot signature and a dot token from the QDX™ ledger 118 with assigned metadata and assigned characteristics. The assigned metadata can delineate a Method of Transport (MoT) with which the stamp can be used. As further discussed below, a Method of Transport is similar to a smart contract; it defines a business workflow and all of the actors and methods that can be used inside of that business workflow. When stamps are provided to an individual or entity, each stamp is linked (at 132) to the known identity (or to the signature or sigil associated with the known identity) through a token stored (at 134) in the QDX™ ledger 118. The individual or entity can then use the stamps in Methods of Transport for which the stamps are approved for use. For example, the stamps can be used for purposes of validating actions, actors, and/or assigned objects in a business workflow. A stamp can thus be linked to a user profile (at 132) that is recorded in the QDX™ ledger 118 (at 134), linked to a Method of Transport (at 136) that is recorded in the QDX™ ledger 118 (at 138), and linked to an assigned object (at 140) that is recorded in the QDX™ ledger 118 (at 142).

The purchase of stamps can be performed through an exchange 144. For example, cryptocurrency can be used to buy stamps. An exchange can be an entity that facilitates the buying and selling of crypto assets such as Bitcoin, Eth, and other cryptocurrencies. Alternatively, fiat (conventional currency) payment can be collected through a regular payment gateway 146 (e.g., Paypal, Stripe, etc.). Once the dots are purchased, the quantum dots are packaged and delivered (at 148), for example, through a conventional delivery system (e.g., UPS, Federal Express, or USPS shipping services).

Upon purchasing stamps (at 130), the stamps are automatically linked to a known individual or company profile, one or more Methods of Transport with which the stamps can be used, and/or one or more assigned objects. Profiles, Methods of Transport, and assigned objects are, at that time or at a later time, registered to the QDX™ ledger 118. As an example, a producer of a designer purse may want to create a workflow (i.e., a Method of Transport) to enable customers to be able to identify their purse. The producer can thus establish (or pay to have established) an appropriate Method of Transport, which may be registered with the QDX™ ledger 118. In addition, every time the producer makes a purse, in which quantum dots are embedded, and the purse is registered, a transaction is generated to create an assigned object (i.e., the purse and the embedded dots), which is written to the QDX™ ledger 118. As an example, the brand or corporate signature for the producer is an assigned object identifier (AOI), which has an object token assigned to it. The object token is tied to the Quantum Dot Address ID (QID) for the dots embedded into the physical purse (i.e., the assigned object physical (AOP)) by the QDX™ ledger 118. Personal identity is then the sigil (which also is an AOI) (and, for example, which may be stamped on the purse) that is then linked to the purse (AOP) in the QDX™ ledger 118. So there is an AOP (Token) for the Product, an AOI (Token) for the producer or object creator (Company) and an AOI (Token) for the individual (Owner of the purse).

Information in the QDX™ ledger 118 can be used in a variety of ways. For example, assigned objects can be identified using an authenticator 150 (i.e., an industrial or mobile quantum dot reader), which detects the spectral signature and validates the data against tokens stored in the QDX™ ledger and, in some cases, metadata stored in the dot ledger 124 or another database. The QDX™ ledger can also be integrated with a third-party workflow integration (e.g., an SAP or Oracle system, or Salesforce) (at 152) that can decipher the business process modeling notation. For example, one of those workflows can be made into a Method of Transport. The QDX™ ledger 118 can also be used for third party audit requests (at 154). For example, a third party can be permitted to attach to a Method of Transport, such that they have read access to transactions that flow through that Method of Transport (e.g., can have read access to see blockchain processes and can see an object in the chain that relates to the Method of Transport). This can be used, for example, by a third-party auditor that needs to be able to validate that a company is doing the right thing.

To create tokens, the QDX™ ledger 118 can use a DAML (Digital Asset Modeling Language created by Digital Asset Holdings, LLC) enabled blockchain provider 156 (e.g., anybody that is capable of interpreting DAML) to create token objects. It is also possible to use not only stamps, but to match assigned objects to a, for example, ERC20 token on Etherium. As a result, it is possible to use objects related to Methods of Transport in third party smart contracts. For example, in transactions between 2 people, person B may exist in another blockchain, so a transfer can effectively create an index between an active object in the QDX™ ledger 118 and a token on another blockchain. Accordingly, a Method of Transport can be created to map to an external blockchain.

Objects and processes that may be defined in the techniques and architectures described above may include the following. A dot ledger can be attached to or can communicate with a quantum dot reactor and can log the creation of the dots. A quantum dot address (QDAddress or QID) is the specific spectrum assignment for a quantum dot batch. In some implementations, the QID is made up of six (6) quantum dots made with the QDX™ process with explicit, specific spectrum responses expressed in nanometers. Each SpectrumID is of a number 440.00 where 400.00 is the actual nanometer of the visible spectrum. In an example implementation, the spectral response can be measured down to 10 nm segments for the SpectrumID of each individual QDX™ Dot. More narrow measurements can also be used in accordance with the capabilities of spectrometers. Each batch of QDX™ Dots can be assigned a BatchID upon manufacturing and that BatchID can be associated with a ReactorID. The form for the QID can be, for example:
Position1[SpectrumID].Position2[SpectrumID.Position3[SpectrumID].Position[SpectrumID].Position5[SpectrumID].Position6[SpectrumID] (e.g., The QID can be expressed as: 640.720.860.690.910.700)

A quantum dot is an artificial atomic crystal which can be made from a specification. The specification can include a recipe and can define materials, time, pressure and temperature measured in stages. Two or more closely spaced quantum dots become artificial molecules (or artificial atoms). Materials are substances used in the creation of quantum dots. A BatchID can be assigned to every production run from a reactor. A medium is a material that a quantum dot is embedded within. Examples include paper, ink, and leather. A date specifies when a batch of quantum dots was created with a specification from an order. A specification can include the recipe, quantity and medium required to make a specific quantum dot along with the specific QDAddress of the batch to create the assigned object. An OrderID can provide the index of a specific order and can include a customer name, annualized sequential order number, and a date (e.g., a date the order was received). Registration is the process whereby individuals and business can establish their profiles in the system and buy stamps to use in Methods of Transport (MoT).

An assigned object includes a quantum dot and a medium combined together. The assigned object is given a Quantum ID from the QDX™ ledger and written to blockchain upon creation. For example, a polymer tube for an e-cigarette is created at manufacturing time and quantum dots are embedded based upon a specification which assigns a QDAddress to that tube. The quantum dot-embedded tube is an assigned object (an object in the physical world) which will then be associated with an object token (an object in the digital world).

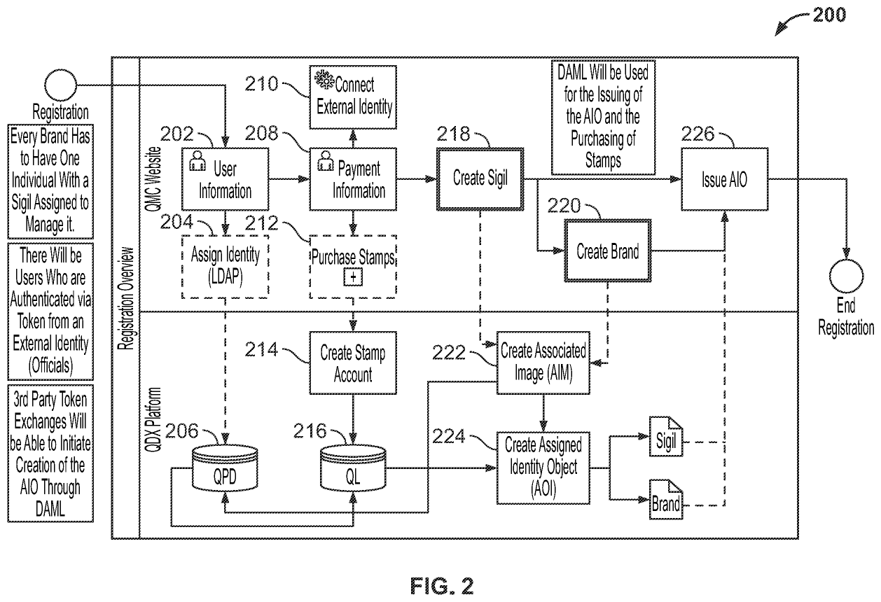

A quantum dot platform registration process 200 is depicted in FIG. 2. A participant can initially be identified by the email associated with an account creation. This can be referred to as the original identity. The participant identity can transition to an AOI when created or remain with OI if they are an official. Identity assignment can start from a web registration page which collects basic information of the participant (at 202): e.g., name, email, address, city, state or province, zip code, phone, and/or company. The participant is then also assigned a secure ID (at 204) and the ID is attached to the record (at 206) which is then sent to LDAP (Lightweight Directory Access Protocol) for registration with the original identity (their original registration email). The secure ID can be stored in a QDX™ platform database 206.

Payment information for the user is received (at 208) and can be used to connect the user (at 210) to an external identity (i.e., an existing identity for the user outside of the platform). The payment information can also be used to purchase stamps (at 212). Stamps are created by a combination of a quantum dot of a specific dot signature derived from its wavelength signature with a dot token created upon its creation from the QDX™ ledger with assigned metadata delineating the Method of Transport (MoT) it can be used with and its assigned characteristics. A stamp account for the user can be created (at 214) and associated with user ID information from the QDX™ platform database 206 in the QDX™ ledger 216.

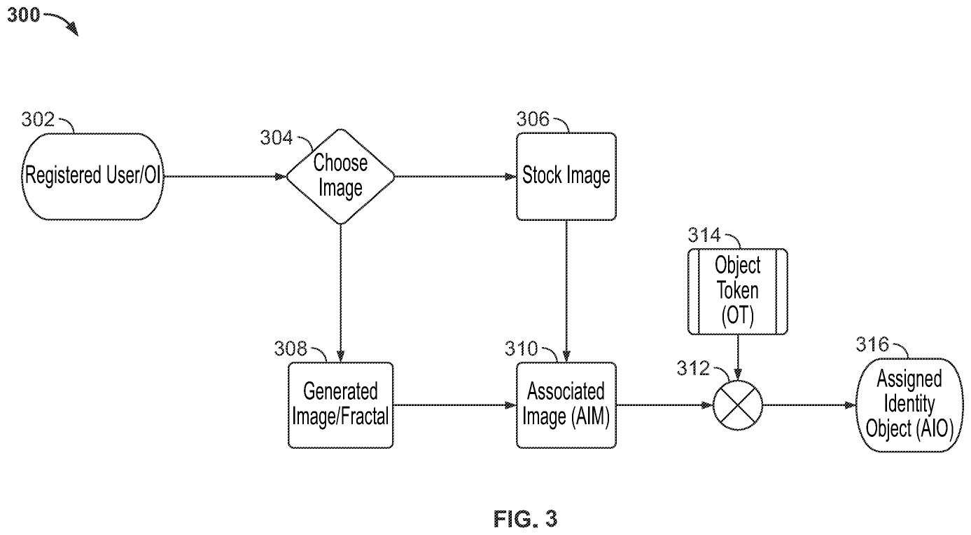

A sigil creation process is initiated (at 218). A sigil is an image combined with a token object from the QDX™ ledger 216 to represent a participant. In some implementations, a participant can have only one sigil. The sigil creation process is further depicted in FIG. 3. A brand creation process is also initiated (at 220). In some implementations, a brand has at least one individual associated with a sigil to manage the brand. A brand is an image combined with a token object from the QDX™ ledger 216 to represent a company. A company can have one or more brands. A company can be a participant with a brand that participates in an MoT. Generally, an associated image is created (at 222) for a sigil and associated with the corresponding user in the QDX™ platform database 206 and for a brand.

An assigned identity object is created (at 224). This object can contain an image chosen by the participant and an object token assigned by the quantum ledger to represent the participant in all MoTs. An assigned identity object (AIO) is created when an associated image (AIM) and an object token are assigned to a registered user or company. These can also be associated with an assigned object such as a physical identity card or other item. The assigned identity object for a sigil or a brand can be issued (at 226) to complete a registration. For example, the assigned identity object can be stored in the QDX™ ledger 216.

FIG. 3 is a flow diagram of a sigil creation process 300. A registered user or original identity 302 chooses an image (at 304). The image can be selected from a stock image 306 or a generated image 308. The selected image becomes the associated image 310 for the user or original identity 302 and is associated (at 312) with an object token 314 to generate an assigned identity object 316 for a sigil. Sigils can thus be a unique graphical image drawn randomly and selected by the user to represent their individual identity in the system. Sigils are paired with a quantum dot identifier (QID) to create a unique token object. A QID (Quantum ID) is a universal identifier assigned by the dot ledger to every object in the system, people, places and things. Associations, indexes and operations work by using the QID. Sigils can be linked to external identities such as an email, driver's license number, passport or other state identifying object.

Methods of Transport describe the behavior of workflow processes. Similar to “smart contracts” they can be expressed in DAML. The following are general MoTs that provide examples:
Two Participants, 1 Object—Participant A is the object creator and the initial object owner that has an assigned object identity (AOI), object X is an assigned object product (AOP), and participant B is a customer (with an AOI) making a purchase of a branded AOP.
Two Objects, 1 Assembly—An Assembly is a combination of one or more AOPs, it has an assembly identifier (AID) which is logged in the QDX™ ledger, but no QID (as it is not “dotted”).
Many Participants, 1 Object—This is usually a continuous chain of custody, from the original object creator through a succession of owners.
Many Objects, 1 Assembly—This is usually the assembly of a large combinations of AOPs into a larger single entity (an assembly with an AID) such as a car, motorcycle or electronics.

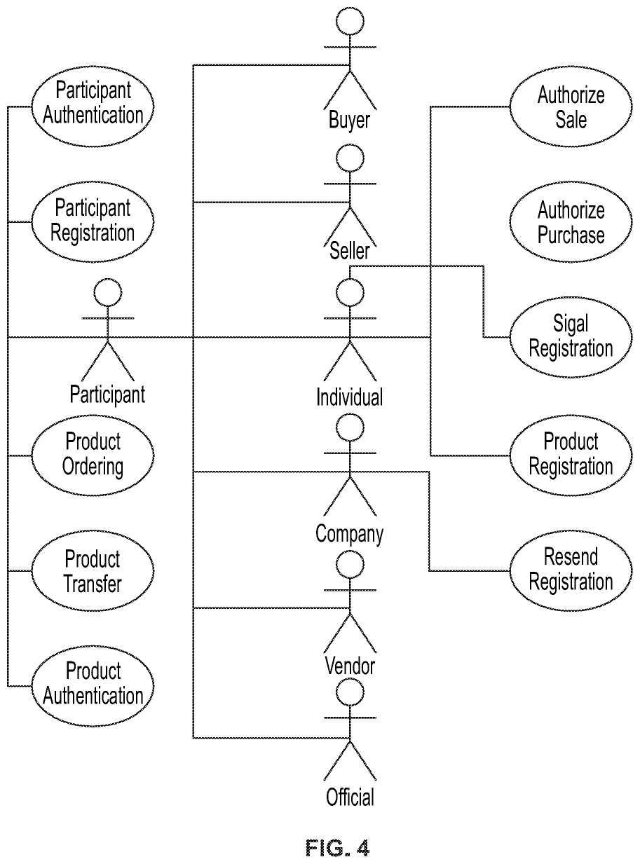

Hereinafter are exemplary use cases that further illustrate the functionality and operations of the systems and methods of the present disclosure. The use cases are best described from a role-based perspective, where a company can be an owner, vendor, distributor, and/or reseller of a product, and a person can be a buyer, agent, seller, and/or owner. FIG. 4 is a logical diagram of roles and persons that can participate in the systems and methods of the present disclosure. Further, the following rules are observed:
Products are assigned objects (QDX™ “dotted”).
Identification, authentication and authorizations transactions are written to the QDX™ Ledger.
Product metadata is stored in the quantum dot database (QD).
QDX™ dot manufacturing information is stored in the QD.
Transactional information for assigned objects (products) is stored in the QL.
Certification is through authentication.
Validation is through authentication.
Identity is through identification.
Transfer of products, funds (or any other product to person or location) is authorization.

Use Case 1: A buyer wants to authenticate her product so that she knows it is really from the proper company. A buyer can use the systems and methods of the present disclosure to validate a product to ensure the product is authentic and not counterfeit.

Use Case 2: A company wants to authenticate its products through its supply chain to prevent counterfeiting. The company can use the systems and methods of the present disclosure to authenticate the entire supply chain so that its product can be verified to be authentic and not counterfeit.

Use Case 3: A company wants to connect its products to customers so that it can provide brand value and understand customer preferences. The company can use the systems and methods of the present disclosure to connect customers to its product to build company good will and customer loyalty. The company may also tap into or understand customer preferences so that it can tailor its offerings and sales strategy accordingly.

Use Case 4: A company wants to identify its products so that it can protect itself from product liability events. Products sold by a company can be identified to avoid becoming liable for inferior counterfeit products.

Use Case 5: A vendor wants to identify products so that it can make sure they are certified from the manufacturer. A manufacturer can use the systems and methods of the present disclosure to certify its products. A vendor can use the systems and methods of the present disclosure to identify the products it plans to buy and resell to ensure it is dealing with certified (authentic) products.

Use Case 6: A buyer wants to associate his identity with a product so that he can prove his ownership. The owner of a product can use the systems and methods of the present disclosure to become associated with a product to demonstrate ownership of the product.

Use Case 7: An official wants to identify a product to determine ownership. An official can use the systems and methods of the present disclosure to verify the identity of the product's owner.

Use Case 8: A buyer wants to authorize the transfer of ownership of a product. The buyer can use the systems and methods of the present disclosure to transfer ownership of a product to itself. A chain of ownership can be established in this manner.

Use Case 9: A company wants to authorize the transfer of ownership of a product. The company can use the systems and methods of the present disclosure to transfer ownership of its product to a buyer.

Use Case 10: A company wants to authorize the value of a product so that it can sell it. The company can use the systems and methods of the present disclosure to establish the value of a product to ensure that the marketplace can be aware of attempts to under-value the product by counterfeits or grey market products.

Use Case 11: An owner wants to authorize the value of a product so that she can sell it. The owner can use the systems and methods of the present disclosure to establish the value of a product it owns.

Use Case 12: A seller wants to authenticate the buyer of a product. The seller can use the systems and methods of the present disclosure to authenticate the buyer and proper payment before transfer of the product.

Use Case 13: A buyer wants to authenticate a product before buying it. A buyer can use the systems and methods of the present disclosure to authenticate a product to avoid inadvertently buying a counterfeit product.

Use Case 14: A buyer wants to authorize funds to buy a product. A buyer can use the systems and methods of the present disclosure to authorize the transfer of currency to buy a product.

Use Case 15: A seller wants to authenticate buyer funds before selling a product. A seller can use the systems and methods of the present disclosure to validate the buyer's payment before the ownership of the product transfers hands.

Use Case 16: A manufacturer wants to assign a manufacturers BatchID (MBID) to a QuantumID for an assigned object.

Use Case 17: A vendor wants to authenticate a manufacturers BatchID (MBID) for a product (AO).

The following rules may be associated with Quantum Dot manufacturing: A QDX™ production license (QPL) can be assigned to all dot manufacturers (DMs). All dot manufacturers will be assigned QDX™ Reactor ID (QRID) which are registered to each quantum reactor (QR). A dot manufacturer has a specification (SPEC) for the creation of the QDO (Quantum Dot Object). A specification contains a QD recipe (QR) for the reactor process (RP) which contains materials, materials processes (MP), and expected output (EO). Each materials process (MP) contains process stages (PS) which include temperature, pressure, time, and state). Expected outputs contain the measurement data (MD) to allow for validation and authentication of the quantum dot object (QDO) to allow for assigning the quantum dot identifier (QID) for each reactor production batch (RPD).

The following exemplary use cases for the systems and methods of the present disclosure are associated with quantum dot manufacturing.

Use Case 18: A dot manufacturer (DM) wants to manufacture quantum dots using the QDX™ reactor (QDR) to a specification.

Use Case 19: An original dot manufacturer (ODM) wants to assign QID to every batch of dot database (QD) made by any dot manufacturer (DM).

Use Case 20: An original dot manufacturer (ODM) wants to monitor and perform analytics on all original dot manufacturer (ODM), quantum database recipe (QR), and quantum database (QD).

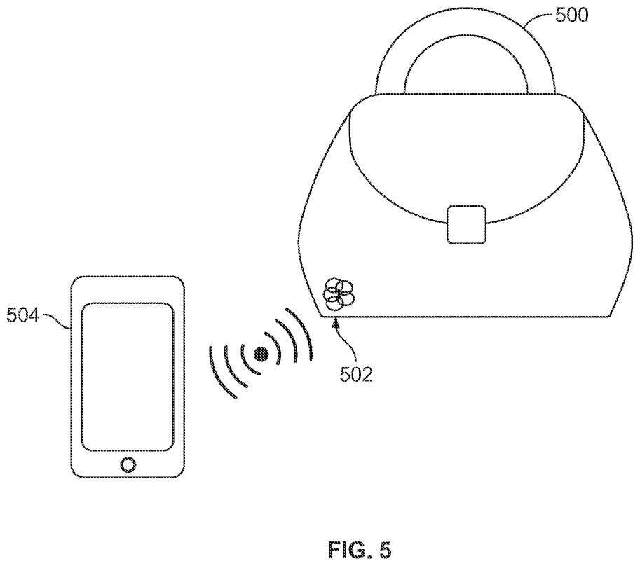

FIG. 5 is an example of a product having embedded quantum dots and a scanner for detecting spectral signatures of quantum dots. The product 500 (a purse) includes quantum dots 502 embedded at a selected location and/or in a selected pattern on the surface of the product 500. The quantum dots can be embedded at the time of manufacture and can have a preselected or predetermined spectral signature when illuminated with a UV or other light source. A scanner or spectrometer 504 can be used to detect the spectral signature emitted by the quantum dots 502. In some implementations, the scanner 504 can include a light source that produces light having a broad range of, or selected, excitation wavelengths. By detecting the light emitted by the quantum dots 502, the scanner 504 or a remote server or computing device can determine whether a spectral signature of the quantum dots 502 matches an expected signature for the product 500.

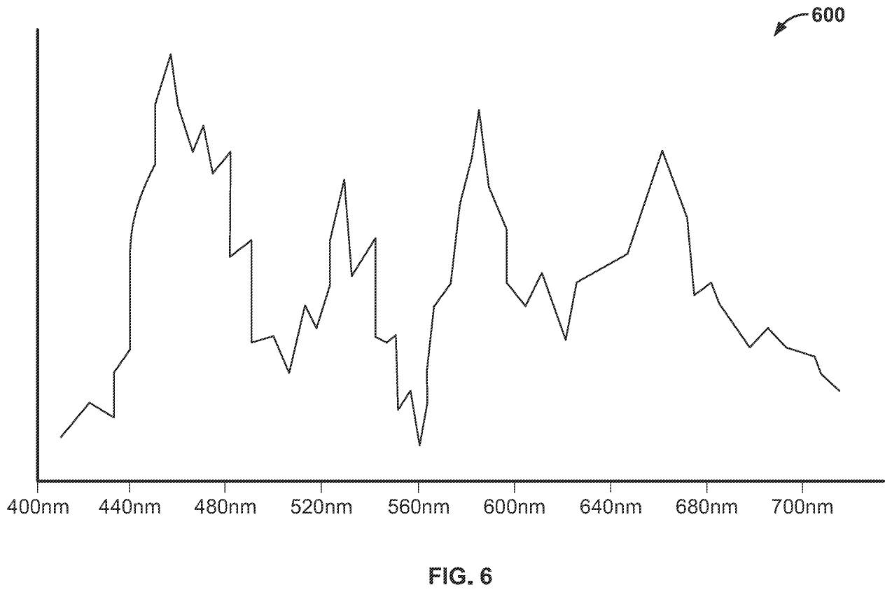

FIG. 6 is an illustrative graph 600 of a spectral signature of a batch of quantum dots. The spectral signature can, for example, be emitted by the quantum dots of FIG. 5. The signature can have peaks and other characteristics at different light wavelengths. The signature results from the wavelengths of light produced when an excitation light source is directed at the quantum dots.

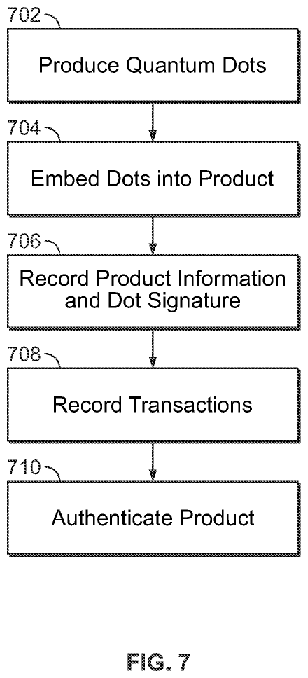

FIG. 7 is a flow diagram of a process 700 for identifying and authenticating a product using quantum dots embedded in or applied to the product. At 702, quantum dots having a predetermined or known set of emitted wavelengths of light are produced. In some cases, production of the quantum dots is controlled to produce quantum dots that have a predetermined spectral signature. Alternatively, the spectral signature of the quantum dots is measured after the quantum dots are produced. The quantum dots are embedded into or applied to a surface of the product at 704. Information identifying the product (e.g., a photograph, a serial number, a model number, or any other information associated with the product) is recorded in association with information identifying the spectral signature of the quantum dots at 706. For example, the information may be recorded in a database and the association between tokens representing the product and the quantum dots can be recorded in a distributed ledger. Subsequent transactions relating to the product can also be recorded in the distributed ledger (e.g., using stamp tokens) at 708. Transactions may be subject to confirming that a registered user is authorized to participate in the transaction, that the transaction complies with a permitted Method of Transport, etc. Transactions may identify, for example, an operation performed on the product, a transfer of ownership or possession, or incorporation of the product into a larger product as a component of that larger product. The product can be authenticated at 710 by detecting a spectral signature of the quantum dots embedded in the product, comparing the signature to an expected signature or retrieving information about a product associated with the detected signature using information and/or tokens stored in a database and/or a distributed ledger, and confirming a match.

The identity of participants in the transactions can be verified as part of the process (e.g., before a transaction is allowed to be recorded). The identity of participants can be verified using any type of identity verification process (e.g., entering a password, facial recognition, or other identification or authentication technique on a device used to initiate recording a transaction). In addition, participants can imprint their own sigil using ink infused with a quantum dot signature that is unique or quasi-unique to the participant (e.g., using a physical stamping device). The same general process 700 used for embedding quantum dots in a product can be used for imprinting a sigil.

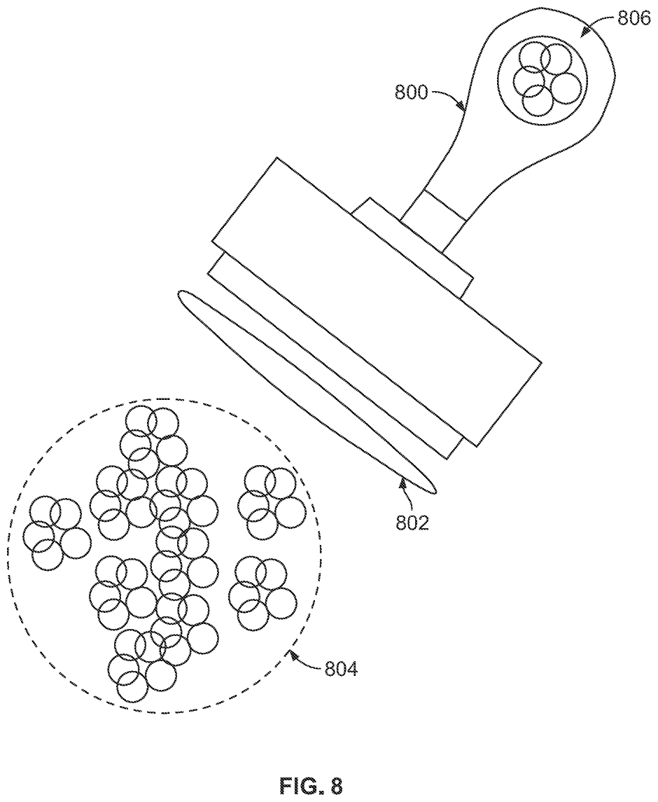

FIG. 8 is an example of a physical stamping device 800 for applying a representation of a sigil or brand to an object. The stamping device 800 includes a unique stamp or shape 802 that can be used to apply an ink 804 to a surface. The ink may be infused, for example, with quantum dots having a unique spectral signature associated with a user of the stamping device 800. The stamping device 800 may also include a user authenticator 806 (e.g., a fingerprint scanner or facial recognition sensor) for authenticating an identity of a user of the stamping device 800. The identity can be recorded along with information about transactions performed using the stamping device 800.

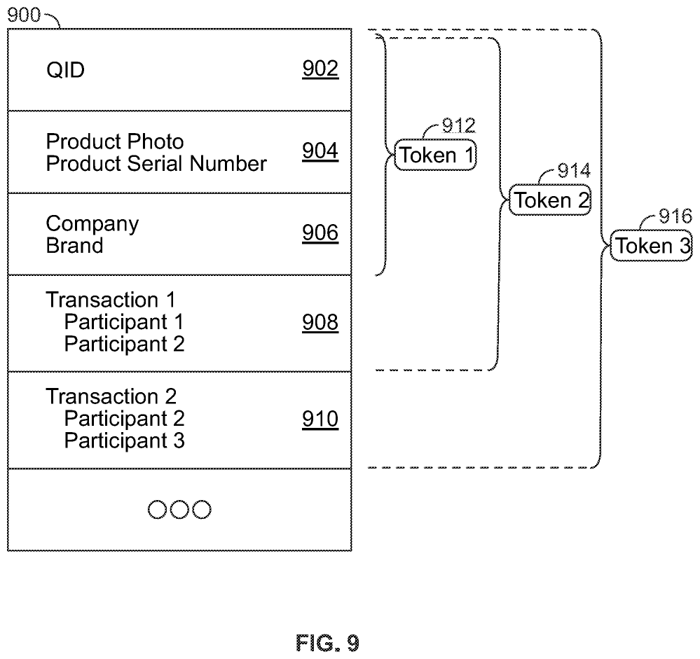

FIG. 9 is an illustrative example of a record 900 for a product having embedded quantum dots. The record 900 can be stored, for example, in a database. When the product is manufactured the quantum ID 902, product identifying information 904, and manufacturer information 906 can be stored in the record, and a first token 912 representing the record can be recorded in the distributed ledger. Details 908 of a subsequent transaction can be added to the record 900, and a second token 914 can be recorded in the distributed ledger. Details 910 of another later transaction can also be added to the record 900 and recorded in the distributed ledger. In some cases, the data in the record can be incorporated into the distributed ledger in the tokens. In other cases, portions of the record 900 may be maintained in a database associated with the manufacturing company or with the product authentication system.

In some implementations, details regarding products and participants are stored in one or more databases or other private data storage, while tokens representing valid objects, participants, transactions, etc. are recorded in a distributed ledger.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions tangibly stored on a computer readable storage device for execution by, or to control the operation of, data processing apparatus. In addition, the one or more computer program products can be tangibly encoded in a propagated signal, which is an artificially generated signal, e.g., a machine-generated electrical, optical, or electromagnetic signal, that is generated to encode information for transmission to suitable receiver apparatus for execution by a computer. The computer readable storage device can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a cross-platform runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, mobile device, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CDROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the subject matter described in this specification can be implemented in a computing system that includes a backend component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such backend, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other.

Data for the computing system can be stored in a database, cloud-based or distributed storage, and/or in a distributed ledger.

While this specification contains many implementation details, these should not be construed as limitations on the scope of the invention or of what may be claimed, but rather as descriptions of features specific to particular implementations of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
applying quantum dots to an object, wherein the quantum dots have an identified spectral response pattern; and
recording data associating the object and the identified spectral response pattern.

2. The method of claim 1 wherein the quantum dots further have one or more identified excitation sources.

3. The method of claim 2 further comprising recording data associating the one or more identified excitation sources with at least one of the object, the identified spectral response pattern, or the quantum dots.

4. The method of claim 1 wherein the data is recorded in a distributed ledger.

5. The method of claim 1 wherein the quantum dots are applied using a sigil application device.

6. The method of claim 1 wherein the sigil application device is adapted to authenticate an identity of a user of the sigil application device.

7. The method of claim 1 further comprising recording one or more transactions in a distributed ledger associating the object and the identified spectral response pattern with the one or more transactions.

8. An apparatus comprising:
an object;
a plurality of quantum dots having an identified spectral response pattern, wherein data associating the object and the identified spectral response pattern is recorded in a database.

9. A system comprising:
a sigil application device;
an ink comprising quantum dots having an identified spectral response pattern, with the ink applied to a surface using the sigil application device; and
a database storing an association between the sigil application device and the quantum dots having the identified spectral response pattern.

10. The system of claim 9 further comprising an authenticator device including a spectrometer to read the quantum dots.
